(19) United States
(12) Patent Application Publication
(10) Pub. No.: US 2023/0038173 A1
(43) Pub. Date: Feb. 9, 2023

(54) EXERCISE RECOMMENDATION THROUGH PARALLEL COMPUTING

(71) Applicant: Regents of the University of Minnesota, Minneapolis, MN (US)

(72) Inventors: Shalini Pandey, Minneapolis, MN (US); Jaideep Srivastava, Minneapolis, MN (US)

(21) Appl. No.: 17/867,028

(22) Filed: Jul. 18, 2022

Related U.S. Application Data
(60) Provisional application No. 63/224,167, filed on Jul. 21, 2021.

(51) Int. Cl. G09B 7/04

(52) U.S. Cl. CPC G09B 7/04; G09B 19/02

(57) ABSTRACT

A method includes conserving processor resources by reducing a number of exercises presented to a student by applying a set of exercises performed by the student and the student's performance on those exercises to a neural network. A respective time period for each exercise in the set of exercises is applied to the neural network wherein each time period represents an amount of time since the student performed the exercise associated with the time period. For a candidate next exercise, a likelihood of the student successfully performing the candidate next exercise is obtained from the neural network and is used to select an exercise to present to the student next.

### CROSS-REFERENCE TO RELATED APPLICATION

The present application is based on and claims the benefit of U.S. provisional patent application Ser. No. 63/224,167, filed Jul. 21, 2021, the content of which is hereby incorporated by reference in its entirety.

### BACKGROUND

Humans and computing systems find it difficult to identify what exercise a student should perform next to most efficiently learn a subject. As a result, computing systems designed to select exercises for students are inefficient and waste computing resources by providing exercises to students that the students are unable to perform.

### SUMMARY

A method includes conserving processor resources by reducing a number of exercises presented to a student by applying a set of exercises performed by the student and the student's performance on those exercises to a neural network. A respective time period for each exercise in the set of exercises is applied to the neural network wherein each time period represents an amount of time since the student performed the exercise associated with the time period. For a candidate next exercise, a likelihood of the student successfully performing the candidate next exercise is obtained from the neural network and is used to select an exercise to present to the student next.

In accordance with a further embodiment, a system includes a plurality of neural networks operating in parallel, each neural network in the plurality providing a likelihood of a student successfully performing a respective candidate next exercise of a plurality of candidate next exercises. Each neural network has a first network layer receiving a plurality of input values and outputting a plurality of output values. Each neural network also has a second network layer receiving the plurality of output values provided by the first network layer and using the plurality of output values to generate a likelihood of a the student successfully performing the respective candidate next exercise associated with the neural network. A selection layer receives the likelihoods produced by the plurality of neural networks and selects one of the plurality of candidate next exercises as a next exercise the student should perform based on the likelihoods produced by the plurality of neural networks.

In accordance with a still further embodiment, a method includes conserving processor resources by reducing a number of exercises presented to a student through steps that include applying a set of exercises performed by the student and the student's performance on those exercises to a neural network. A relation value for each exercise in the set of exercises is applied to the neural network, the relation value for an exercise in the set of exercises representing a relation between the exercise in the set of exercises and a candidate next exercise. For the candidate next exercise, a likelihood of the student successfully performing the candidate next exercise is obtained from the neural network. The likelihood is used to select an exercise to present to the student.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1: provides a high-level block diagram of a first embodiment.

FIG. 2 provides a more detailed block diagram of the embodiment of FIG. 1.

FIG. 3 provides graphs of prediction performance for various models for three different student groups.

FIG. 4 provides a bar chart of weights applied to past exercises to predict performance on a future exercise using two different models.

FIG. 5(a) provides a heatmap of attention weights for a first dataset.

FIG. 5(b) provides a heatmap of attention weights for a second dataset.

FIG. 5(c) provides a heatmap of attention weights for a third dataset.

FIG. 5(d) provides a heatmap of attention weights for a fourth dataset.

FIG. 6 provides a flow diagram of a method of providing a next exercise for a student in accordance with one embodiment.

FIG. 7 provides a block diagram of a system for providing a next exercise to a student in accordance with one embodiment.

FIG. 8 provides an expanded block diagram of portions of the system of FIG. 7.

FIG. 9 provides an expanded block diagram of portions of the system of FIG. 8.

FIG. 10 provides a second expanded block diagram of portions of the system of FIG. 7.

FIG. 11 is a block diagram of a computing device that can be used as a server in the various embodiments.

### DETAILED DESCRIPTION

### Introduction

Real-world education service systems, such as massive open online courses (MOOCs) and online platforms for intelligent tutoring systems on the web offers millions of online courses and exercises. Unfortunately, the large number of available courses and exercises makes it difficult for students to pick the right course and exercise set so that the student continues to progress through material. Many courses and exercise sets contain the same information as other courses and exercise sets. As such, it is easy for students to unknowingly select courses and exercise sets that they have already mastered. At the same time, many courses and exercise sets require a certain level of background knowledge before a student will be able to successfully complete the course/exercise set. As a result, it is easy for students to mistakenly select a course/exercise set that is too advanced for them and which they will be unable to complete.

The present embodiments provide a system to identify which exercise a student should perform next. The embodiments use the student's success at performing other exercises, the time that has passed since those exercises were performed, models of the relationship between success performing one exercise and success performing another exercise, and models of the loss of ability over time to generate likelihoods that the student will be able to successfully perform each of a set of candidate exercises.

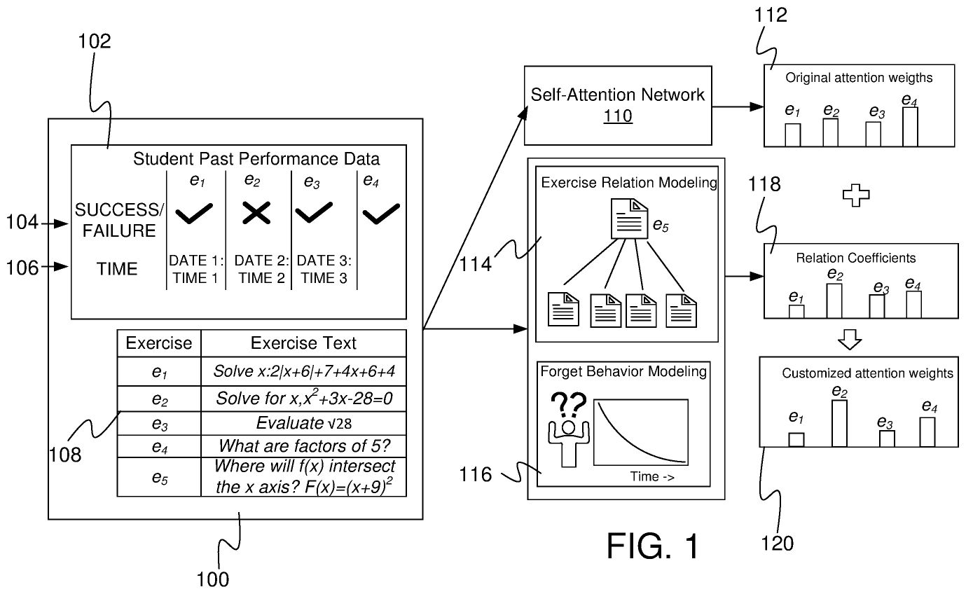

FIG. 1 shows a high-level block diagram of such a system, referred to as Relation-aware Knowledge Tracing (RKT), in accordance with one embodiment. The inputs 100 to the system are shown on the left side of FIG. 1 and include exercise text 108 and student performance data 102 consisting of success/failure 104 at each of a set of exercises as well as a date/time 106 when the student performed the exercise. Exercise text 108 includes content for exercises performed by the student and candidate exercises that the student can perform next. Inputs 100 are provided to a self-attention network 110 which determines a set of attention weights 112 for each candidate next exercise. The set of attention weights 112 for a candidate next exercise includes a self-attention weight for each exercise the student has already performed. Inputs 100 are also applied to an exercise relation model 114 and a forget behavior model 116 to generate a set of exercise relation coefficients 118. A separate relation coefficient is generated for each candidate next exercise/already-performed exercise pair. Exercise relation coefficients 118 reflect the relation between past exercises performed by the student and each candidate next exercise. In addition, exercise relation coefficients 118 reflect the amount of skill loss that is expected to have occurred since the past exercise was performed.

Each set of self-attention weights is adjusted based on a respective relation coefficient to produce a set of adjusted self-attention weights 120. The adjusted self-attention weights are then applied to a neural network to determine a probability of each candidate next exercise.

The mathematical notations used herein are summarized in Table 1.

TABLE 1
Notations

| Notations | Description |
|---|---|
| E | total number of exercises |
| xᵢ | ith interaction tuple of a student |
| d | latent vector dimensionality |
| e | sequence of exercises solved by the student |
| P | Positional embedding matrix |
| A | exercise-exercise relation matrix |
| R | relation coefficients of past interactions |
| \hat{x}ᵢ | ith interaction embedding |
| P | Positional embedding matrix |
| l | maximum sequence length |
| E | Exercise embedding |
| X | Interaction sequence of a student: |
| | (xᵢ, x₂, . . . , xᵢ) |

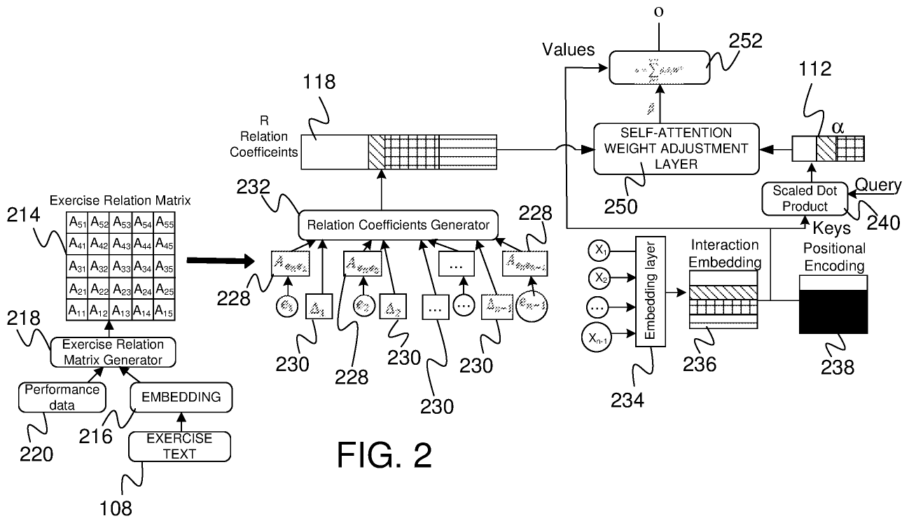

FIG. 2 provides a more detailed block diagram of an embodiment. In FIG. 2, exercise relation model 114 of FIG. 1 takes the form of an exercise relation matrix 214, which provides an exercise relation value for each possible pair of exercises that can be formed from the exercises in exercise text 108. To form the exercise relation values, the text of each exercise is first embedded into a respective exercise embedding Eᵢ by a text embedding layer 216.

For this, the embodiments exploit a word embedding technique and learn a function ƒ:M→ [symbol] ^{d}, where M represents the dictionary of words and f is a parameterized function which maps words to d-dimensional distributed vectors. In the look-up layer, exercise content is represented as a matrix of word embeddings. Then the embedding of an exercise i, Eᵢ∈ [symbol] ^{d} is obtained by taking a weighted combination of the embeddings of all the words present in the text of the exercise i using Smooth Inverse Frequency (SIF). SIF downgrades unimportant words such as but, just, etc., and keeps the information that contributes the most to the semantics of the exercise. Thus, the exercise embedding for an exercise i is obtained as:

$${E}_{i} = \frac{1}{\vert {s}_{i} \vert} {\sum }_{w ∈ {s}_{i}} \frac{a}{a + p ( w )} f ( w ) , \qquad ( 1 )$$

where a is a trainable parameter, sᵢ represents the text of ith exercise, and p(w) is the probability of word w.

Once the texts of the exercises have been embedded, the embedded values are provided to an exercise relation matrix generator 218 together with performance data 220, which contains performance data for a large number of students. Performance data 220 indicates whether a student performed an exercise correctly and the order in which each student performed each exercise.

Since the relations between exercises are not explicitly known, the embodiments first infer these relations from the embedded text values and performance data 220 to build exercise relation matrix 214, also denoted as A∈ [symbol] ^{E×E} such that A_{i, j} represents the importance that performance on exercise j has on the performance on exercise i.

In particular, performance data 220 is used to compute a Phi coefficient. Mathematically the Phi coefficient that describes the relation from j to i is calculated as,

$${∅}_{i , j} = \frac{{n}_{11} {n}_{00} - {n}_{01} {n}_{10}}{\sqrt{{n}_{1 *} {n}_{0 *} {n}_{* 1} {n}_{* 0}}} \qquad ( 2 )$$

where the variables used in equation 2 are defined in Table 2.

TABLE 2
A contingency table for two exercises i and j

exercise i

| | | incorrect | correct | total |
|---|---|---|---|---|
| exercise j | incorrect | n₀₀ | n₀₁ | n₀* |
| | correct | n₁₀ | n₁₁ | n₁* |
| | total | n*₀ | n*₁ | n |

The value of ϕ_{i, j} lies between −1 and 1 and a high ϕ_{i, j} score means students' performance at j play an important role in deciding their performance at i. The embodiments choose Phi coefficients among other correlation metrics to compute the relation between exercises because: 1) it is easy to interpret, and 2) it explicitly penalizes when the two variables are not equal.

The embedded text values are used to determine the semantic similarity between two exercises. The embodiments first obtain the exercise embedding of i, Eᵢ and j, Eⱼ, and then compute the similarity between exercises using cosine similarity of the embeddings. Formally, similarity between exercises is calculated as:

$$s i {m}_{i , j} = \frac{{E}_{i} {E}_{j}}{{‖ {E}_{i} ‖}_{2} {‖ {E}_{j} ‖}_{2}} \qquad ( 3 )$$

Finally, the relation of exercise j with exercise i is calculated as:

$${A}_{i , j} = \{ \begin{matrix}{∅}_{i , j} + {sim}_{i , j} , & if {sim}_{i , j} + {∅}_{i , j} > θ \\ 0 , & otherwise ,\end{matrix} \qquad ( 4 )$$

where θ is a threshold that controls sparsity of relation matrix 214.

Exercise relation matrix 214 is used for all students. However, the relation coefficients used to adjust the self-attention weights are student specific. To generate relation coefficients 118, the exercises performed by the student and a candidate exercise are used to select relation values 228 from exercise relation matrix 214. More formally, given the past exercises solved by a student, (e₁, e₂, . . . , eₙ₋₁) and the next exercise eₙ for which the present embodiments want to predict the student's performance, the present embodiments compute the exercise-based relation coefficients from the eₙ^{th} row of exercise relation matrix, Aₑ_{ₙ} as R^{E}=[Aₑ_{ₙ}ₑ_{₁}, Aₑ_{ₙ}ₑ_{₂}, . . . , Aₑ_{ₙ}ₑ_{ₙ₋₁}], which form relation values 228. Thus, if the student had performed three exercises and relation coefficients were being generated for a selected candidate exercise, three relation values would be selected—a first relation value for the relation between the first performed exercise and the candidate exercise, a second relation value for the relation between the second performed exercise and the candidate exercise, and a third relation value for the relation between the third performed exercise and the candidate exercise.

For each exercise that the student performed, the time since that exercise was performed is also retrieved to form times 230. The selected relation values 228 and the retrieved times 230 are then applied to relation coefficient generator 232.

In relation coefficient generator 232, times 230 are used to generate a forget behavior based relation coefficient. Learning theory has revealed that students forget the knowledge learnt with time, known as forgetting curve theory, which plays an important role in knowledge tracing. Naturally, if a student forgets the knowledge gained after a particular interaction i, the relevance of that interaction for predicting student performance at the next interaction should be diminished, irrespective of the relation between exercises involved. The challenge is to identify the interactions whose knowledge the student has forgotten. Since students forget with time, the present embodiments employ a kernel function that models the importance of interaction with respect to time interval. The kernel function is designed as an exponentially decaying curve with time to reduce the importance of a past interaction as the time interval increases following the idea from forgetting curve theory. Specifically, given the time sequence of interactions (past exercises performed by the student) t=(t₁, t₂, . . . , tₙ₋₁) and the time at which the student attempts a next exercise tₙ, the present embodiments compute the relative time interval between the next interaction and the ith interaction as Δᵢ=tₙ−tᵢ. In accordance with most embodiments, time tₙ is the current time and thus Δi is simply the time since the past exercise was performed. In accordance with one embodiment, relation coefficient generator 232 computes the forget behavior based relation coefficients, R^{T}=[exp(−Δₗ/Sᵤ), exp(−Δ₂/Sᵤ), . . . , exp(−Δₙ₋₁/Sᵤ)], where Sᵤ refers to relative strength of memory of student u and is a trainable parameter in our model.

The forget behavior based relation coefficient of each performed exercise is then combined with the relation value for the performed exercise to form a relation coefficient for the performed exercise relative to the candidate exercise as:

R=softmax(R^{E}+R^{T}), (5)

Self-attention network 110 produces attention weights 112 based on the student's previous interaction sequence X={x₁, x₂, . . . , xₙ₋₁} where each interaction in the sequence includes an exercise performed by the student, the correctness of the student's answer (student's performance), and the time when the exercise was performed. Thus, each interaction is characterized by a tuple xᵢ=(eᵢ, rᵢ, tᵢ), where eᵢ∈{1, . . . , E} is the exercise attempted, rᵢ∈{0, 1} is the correctness of the student answer, and tᵢ∈ [symbol] + is the time at which the interaction occurred. The self-attention weights are also based on candidate exercise eₙ that is being evaluated.

Before the self-attention weight can be determined, each sequence in the interaction sequence is passed through an embedding layer 234 to form an interaction embedding 236. To obtain an embedding of a past interaction j, (eⱼ, rⱼ, tⱼ), the present embodiments first obtain the corresponding exercise representation using Equation (1). To incorporate the correctness score rᵢ, the present embodiments extend it to a feature vector rⱼ=[rⱼ, rⱼ, . . . , rⱼ]∈ [symbol] ^{d} and concatenate it to the exercise embedding. Also, the present embodiments define a positional embedding matrix as P∈ [symbol] ^{l×2d} to introduce the sequential ordering information of the interactions, where l is the maximum allowed sequence length. The positional encoding 238 is particularly important in knowledge tracing problem because a student's knowledge state at a particular time instance should not show wavy transitions.

Combining the interaction embedding 236 and the positional encoding 238 produces an input value for an interaction of:

\hat{x}ⱼ=[Eₑ_{ⱼ}⊕rⱼ]+Pⱼ (6)

Finally, the input interaction sequence is expressed as \hat{X}=[x̅₁, \hat{x}₂ . . . \hat{x}ₙ].

Attention weights 112 are learned by self-attention network 110 using a scaled dot-product attention mechanism 240 such that

$${α}_{j} = \frac{exp ( {e}_{j} )}{{\sum }_{k = 1}^{n - 1} exp ( {e}_{k} )} , {e}_{j} = \frac{{E}_{{e}_{n}} {{W}^{Q} ( {\hat{x}}_{j} {W}^{K} )}^{T}}{\sqrt{d}} \qquad ( 7 )$$

Where aⱼ is a self-attention weight for the jth previous interaction, Eₑ_{ₙ} is the text embedding of candidate exercise eₙ, W^{Q}∈ [symbol] ^{d×d} and W^{K}∈ [symbol] ^{d×d} are projection matrices for query and key, respectively, \hat{x}ⱼ is the input value for the jth previous interaction and d is the latent vector dimensionality. Finally, a self-attention adjustment layer 250 combines the attention weights with the relation coefficients, by adding the two weights:

βⱼ=λαⱼ+(1−λ)Rⱼ, (8)

where Rⱼ is the jth element of the relation coefficient R. The present embodiments use the addition operation to avoid any significant increase in computation cost. λ is a tunable parameter. An output layer 252 produces the output, o∈ [symbol] ^{d}, which in one embodiment is obtained by the weighted sum of linearly transformed interaction embedding and position embedding:

$$o = {\sum }_{j = 1}^{n - 1} {β}_{j} {\hat{x}}_{j} {W}^{V} , \qquad ( 9 )$$

where W^{V}∈R^{d×d} is the projection matrix for value space.

Since the self-attention model works with sequence of fixed length, the present embodiments convert the input sequence, X=(x₁, x₂, . . . , x_{|X|}), into sequence of fixed length l before feeding it to RKT. If the sequence length, |X| is less than l, the present embodiments repetitively add a padding to the left of the sequence. However, if |X| is greater than l, the present embodiments partition the sequence into subsequences of length l.

The objective of training is to minimize the negative log likelihood of the observed sequence of student responses under the model. The parameters are learned by minimizing the cross entropy loss between p and r at every interaction.

$$ℒ = - {\sum }_{i ϵ I} ( {r}_{i} log ( {p}_{i} ) + ( 1 - {r}_{i} ) log ( 1 - {p}_{i} ) ) , \qquad ( 11 )$$

where I denotes all the interactions in the training set.

### EXPERIMENTAL SETTINGS

### Datasets

To evaluate the present embodiments, the performance of the present embodiments with three real-world datasets was determined.
ASSISTment2012(ASSIST2012): This dataset is provided by ASSISTment online tutoring platform and is widely used for KT tasks.
JunyiAcademy (Junyi) This dataset was collected by JunyiAcademy in 2015. The available dataset only contains the exercising records of students. To obtain the textual content, the data from their website was scraped. Overall, this dataset contains 838 distinct exercises.
Peking Online Judge (POJ) This dataset is collected from Peking online platform of coding practices and consists of computer programming questions.

For all these datasets, students who attempted fewer than two exercises were removed and then those exercises which were attempted by fewer than two students were removed. The complete statistical information for all the datasets can be found in Table 3.

TABLE 3
Dataset Details

| | ASSIST2012 | Junyi | POJ |
|---|---|---|---|
| # students | 39,364 | 238,120 | 22,916 |
| # exercises | 58,761 | 684 | 2,751 |
| # Interactions | 4,193,631 | 26,666,117 | 996,240 |
| Avg exercise record/student | 107 | 111.99 | 43.47 |
| Duration of data collection | 365 days | 1095 days | 258 days |

### Metrics

The prediction of student performance is considered in a binary classification setting i.e., answering an exercise correctly or not. Hence, the experiments compare the performance using the Area Under Curve (AUC) and Accuracy (ACC) metric. The experiments trained the model with the interactions in the training phase and during the testing phase, the experiments update the model after each exercise response is received. The updated model is then used to perform the prediction on the next exercise. Generally, the value 0.5 of AUC or ACC represents the performance prediction result by randomly guessing, and the larger, the better.

### Approaches

The experiments compare our model against the state-of-the-art methods.
DKT: This is a seminal method that uses single layer LSTM model to predict the student's performance. In the experiment's implementation of DKT, norm-clipping and early stopping were used to improve the performance of DKT as has been employed in [41].
SAKT This model employs self-attention mechanism to assign weights to the previously answered exercises for predicting the performance of the student on a particular exercise.
DKVMN: This is a Memory Augmented Recurrent Neural Network based method where in the relation between different knowledge concepts are represented by the key matrix and the student's mastery of each knowledge concept by the value matrix.
DKT+Forget This is an extension of DKT method which predicts student performance using both the student's learning sequence and forgetting behavior.
EERNN: This model utilizes both the textual content of exercises and student's exercising records to predict student performance. They use RNN as the underlying model to learn the exercise embedding and the student knowledge representation. Furthermore, they attend over the past interactions using the cosine similarity between the past interactions and the next exercise.
EKT This model is an extension of the EERNN model which also tracks student knowledge acquisition on multiple skills. Specifically, it models the relation between the underlying Knowledge Concepts to enhance the EERNN model.

### Results and Discussion

### Student Performance Prediction (RQ1)

Table 4 shows the performance of all baseline methods and the present embodiments. Different kinds of baselines demonstrate noticeable performance gaps. SAKT model shows improvement over DKT and DKVMN model which can be traced to the fact that SAKT identifies the relevance between past interactions and next exercise. DKT-Forget further gains improvements most of the time, which demonstrates the importance of taking temporal factors into consideration. Further, EERNN and EKT incorporate textual content of exercises to identify which interaction history is more relevant and hence perform better than those models which do not take into account these relations. The present embodiments (RKT) performs consistently better than all the baselines. Compared with other baselines, RKT is able to explicitly capture the relations between exercises based on student performance data and text content. Additionally, it models learner forget behavior using a kernel function which is more interpretable and proven way to model human memory compared to DKT+forget model.

TABLE 4
Performance comparison. The best performing method
is boldfaced, and the second best method in each
row is underlined. Gains are shown in the last row.

| | ASSIST2012 | | POJ | | Junyi | |
|---|---|---|---|---|---|---|
| | AUC | ACC | AUC | ACC | AUC | ACC |
| DKT | 0.712 | 0.679 | 0.656 | 0.691 | 0.814 | 0.744 |
| SAKT | 0.735 | 0.692 | 0.696 | 0.705 | 0.834 | 0.757 |
| DKVMN | 0.701 | 0.686 | 0.704 | 0.700 | 0.822 | 0.751 |
| DKT + Forget | 0.722 | 0.685 | 0.662 | 0.700 | 0.840 | 0.759 |
| EERNN | 0.748 | 0.698 | 0.733 | 0.720 | 0.837 | 0.758 |
| EKT | 0.754 | 0.702 | 0.737 | 0.729 | 0.842 | 0.759 |
| RKT | 0.793 | 0.719 | 0.827 | 0.774 | 0.860 | 1.050 |
| Gain % | 5.172 | 2.422 | 12.212 | 6.173 | 1.775 | 1.050 |

Performance comparison w.r.t. interaction sparsity. One benefit of exploiting the relations between interactions is that it makes the present embodiment robust towards sparsity of dataset. Exploiting the relation between different exercises can help in estimating student performance at related exercises, thus alleviating the sparsity issue.

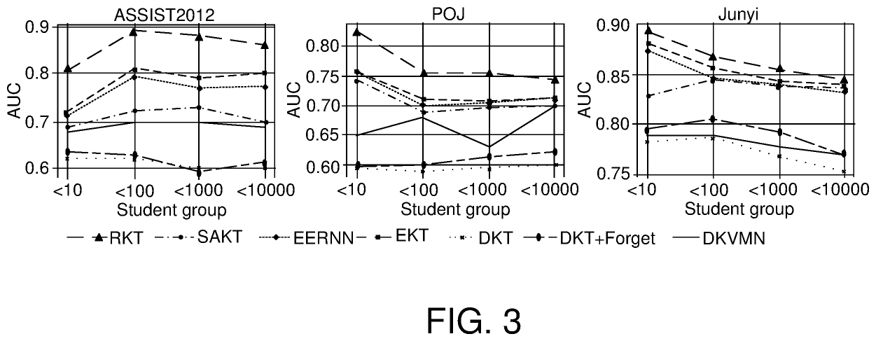

To verify this, experiments were performed over student groups with different numbers of interactions. In particular, the experiments generate four groups of students based on interaction number per user, thus generating groups with less than 10, 100, 1000, 10000 interactions, respectively. The performance of all the methods is displayed in FIG. 3. The experiments find that RKT outperforms the baseline models in all the cases, signifying the importance of leveraging relation information for predicting performance. Also, the performance gain of RKT for student groups with fewer interactions is more significant.

### Ablation Study (RQ2)

To get deep insights on the RKT model of the present embodiments, the contributions of various components involved in the model were investigated using ablation experiments. In Table 5, there are seven variations of RKT, each of which takes out one or more components from the full model. Specifically: PE, TE, RE refer to RKT without position encoding, forget behavior modeling and exercise relation modeling, respectively. PE+TE, PE+RE, TE+RE refer to the removal of two components simultaneously, i.e. position encoding and forget behavior modeling, position encoding and exercise relation modeling, and exercise relation modeling and forget behavior modeling, respectively. And finally, PE+RE+TE refers to RKT that does not model the position encoding, forget behavior modeling and exercise relation modeling for interaction representation. The result in Table 5 indeed shows many interesting conclusions.

TABLE 5
Ablation Study

| | ASSIST2012 | | POJ | | Junyi | |
|---|---|---|---|---|---|---|
| | AUC | ACC | ACU | ACC | ACU | ACC |
| PE | 0.788 | 0.712 | 0.790 | 0.749 | 0.848 | 0.763 |
| TE | 0.787 | 0.712 | 0.816 | 0.766 | 0.835 | 0.758 |
| RE | 0.755 | 0.696 | 0.686 | 0.710 | 0.835 | 0.763 |
| PE + TE | 0.778 | 0.705 | 0.788 | 0.746 | 0.833 | 0.754 |
| PE + RE | 0.759 | 0.699 | 0.676 | 0.700 | 0.832 | 0.757 |
| RE + TE | 0.735 | 0.692 | 0.696 | 0.705 | 0.834 | 0.757 |
| PE + RE + TE | 0.730 | 0.684 | 0.667 | 0.693 | 0.830 | 0.756 |
| RKT | 0.793 | 0.719 | 0.827 | 0.7740 | 0.860 | 0.770 |

First, the more information a model encodes, the better the performance, which agrees with intuition. Second, for all datasets, removing exercise relation modeling causes the most drastic drop in performance. This validates that explicitly learning exercise relations is important for improving the performance of knowledge tracing models.

### Attention Weights Visualization (RQ3)

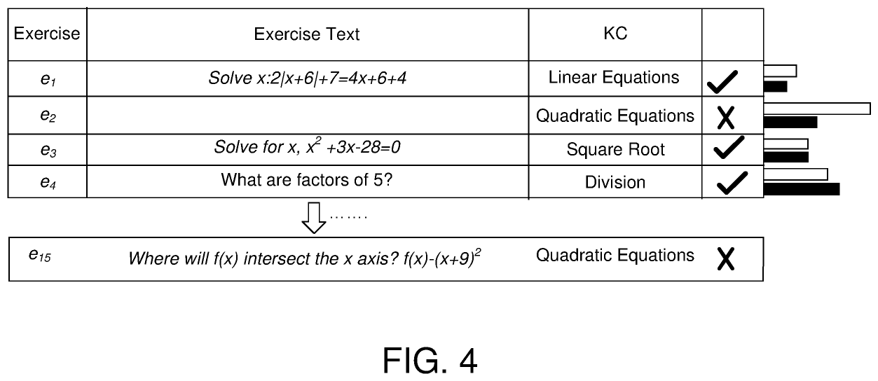

To evaluate how RKT differs from SAKT, the attention weights obtained from both these models were compared to each other. Specifically, one student from the Junyi dataset was selected and the attention weights corresponding to the past interactions for predicting her performance at exercise e₁₅ were determined. FIG. 4 shows the weights assigned by both SAKT and RKT (bar graphs on far right with white bars for RKT and black bars for SAKT, the size of the bars indicating the size of the adjusted self-attention weights). The present embodiments see that compared to SAKT, RKT places more weight on e₂ which belongs to same knowledge concept as e₁₅ and have stronger relation. Since the student gave wrong answer to e₂, she has not yet mastered “Quadratic Equations”. As a result, RKT predicts that the student will not be able to answer e₁₅. Thus, it is beneficial to consider relations between exercises for knowledge tracing.

Experiments were also performed to visualize the attention weights assigned by RKT on different datasets. Recall that at time step tᵢ, the relation-aware self-attention layer in the present embodiment's model revises the attention weights on the previous interactions depending on the time elapsed since the interaction and the relations between the exercises involved. To this end, the present embodiments examine all sequences and seek to reveal meaningful patterns by showing the average attention weights on the previous interactions.

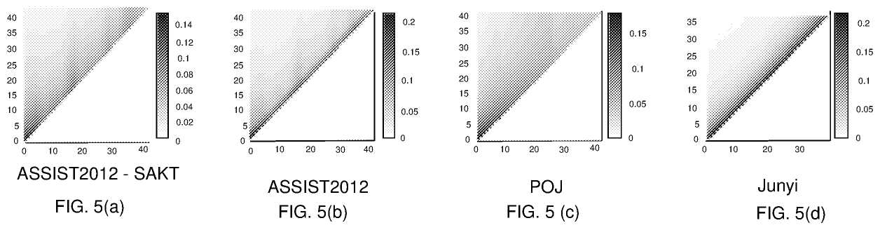

FIGS. 5(a), 5(b), 5(c) and 5(d) show heatmaps of an attention weight matrix where (i,j)th element (i along horizontal axis, j along vertical axis) represents the attention weight on jth element when predicting performance at ith interaction. Note that when the present embodiments calculate the average weight, the denominator is the number of valid weights, so as to avoid the influence of padding for short sequences. The present embodiments consider a few comparisons among the heatmaps:
FIGS. 5(b), 5(c) and 5(d): The heatmap representing the attention weights pertaining to different datasets reveals that recent interactions are given the higher weights compared to other interaction. It can be attributed to the forget behavior of learning process such that only the recent interactions can inform the student knowledge state.
FIG. 5(b) vs. FIG. 5(c): This comparison shows the weights assigned by RKT on two different types of dataset. In ASSIST2012 dataset, the exercises are sequenced for skill-building, i.e., they are organized so that a student can master one skill first and then learn the next skill. As a result, in ASSIST2012 the exercises adjacent to each other are related. While, in POJ dataset, student chooses exercises based on their needs. As a result, the heatmap corresponding to ASSIST2012 dataset has attention weights concentrated towards the diagonal elements, while for POJ the attention weights are spread across the interactions.
FIG. 5(a) vs. FIG. 5(b): This comparison shows the effect of relation information for revising the attention weights. Without relation information the attention weights are more distributed over previous interaction, while the relation information concentrates the attention weights closer to diagonal as adjacent interactions in ASSIST2012 have higher relations.

Prior art systems that provide exercises to students are computationally inefficient and waste significant computing resources. In particular, prior art systems provide a large number of exercises that are beyond a student's ability. Since such exercises are of no use to the student, the system is wasting computing resources when it provides such exercises. In addition, prior art systems do not scale well with increases in the number of candidate exercises and tend to operate slower with increases in the number of candidate exercises. The embodiments described herein provide fewer useless exercises to students thereby improving the efficiency of the system. In addition, the embodiments provide multiple layers of parallel computing that improve the efficiency of delivering exercises to students.

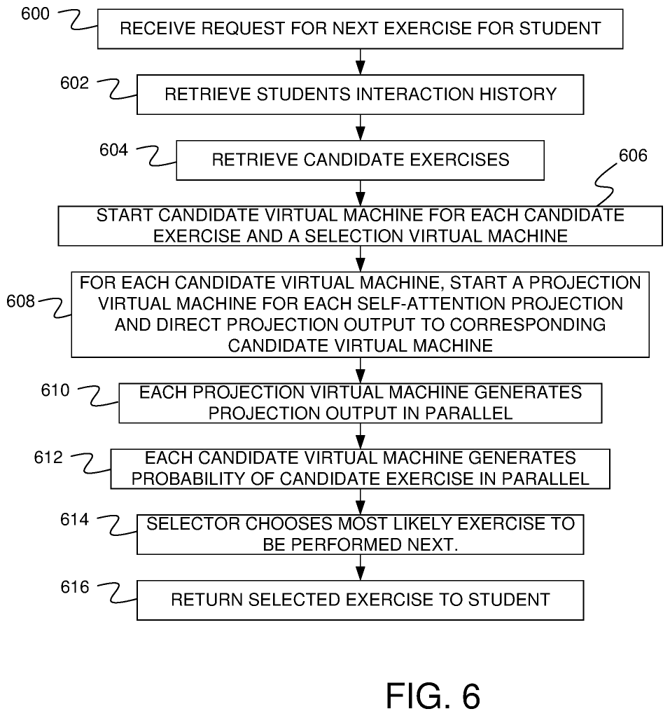

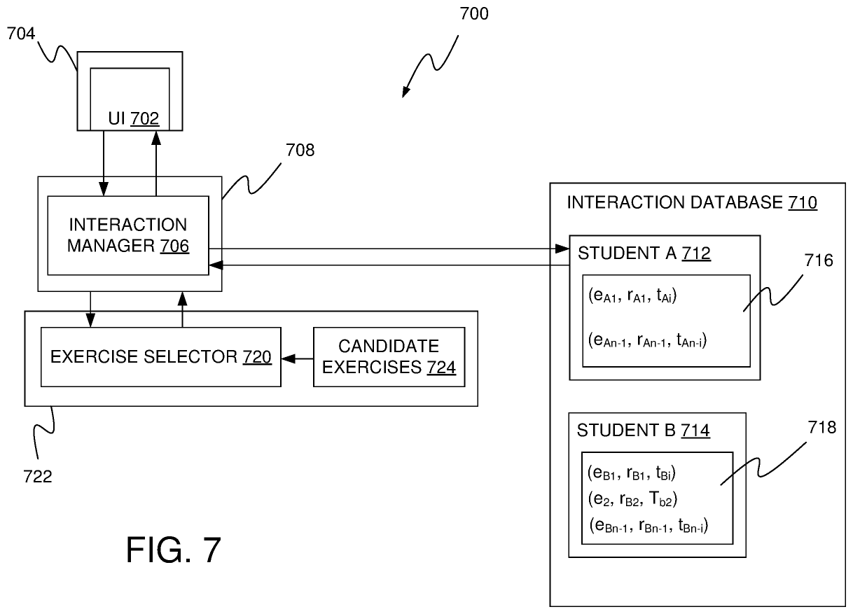

FIG. 6 provides a method for improving the operation of computers while selecting an exercise for a student to perform utilizing parallel computing. FIG. 7 provides a block diagram of a system 700 used in the method of FIG. 6.

In step 600, an interaction manager 706, executing on a server 708, receives a request for a next exercise for a student from a user interface 702 executing on a device 704. Device 704 can be any computing device or mobile device, such as a phone. Interaction manager 706 is responsible for proposing a next exercise for a student to perform as well as maintaining a record of interactions between the student and various exercises. Each interaction consists of an identifier for the exercise, an indication of whether the student performed the exercise correctly, and a time when the student performed the exercise. Interaction manager 706 stores each student interaction in an interaction database 710, which may be located within server 708 or on a separate server. In interaction database 710, there is a separate student record for each student, such as student records 712 and 714, with each student record containing a list of interactions associated with the student, such as interaction list 716 and interaction list 718.

Upon receiving the request for a next exercise for a student, interaction manager 706 uses the identity of the student to retrieve the student's list of past interactions from interaction database 710 at step 602. Interaction manager 706 then provides this list of past interactions to an exercise selector 720 executing on a server 722. In accordance with one embodiment, servers 708 and 722 may be the same server.

At step 604, exercise selector 720 retrieves a set of candidate exercises 724, each of which is a candidate to be provided to the student as their next exercise. Candidate exercises 724 can include all exercises available to any student or may be limited to candidate exercises assigned to a particular student based on a curriculum selection made by the student or a teacher. In addition, candidate exercises 724 can be filtered by exercise selector 720 based on the interaction history of the student. In particular, exercises that have been performed by the student correctly within a threshold period of time can be excluded from the candidate exercises such that the student will not be given the same exercise to perform again if they have recently performed the exercise correctly. Note that a student may receive the same exercise again if the time period since the student correctly performed the exercise is sufficiently long that it is expected that the student may have forgotten how to perform the exercise.

At step 606, exercise selector 720 starts candidate virtual machines for each candidate exercise and a selection virtual machine for selecting a candidate. Although referred to as a virtual machine below, other isolated computing structures may be used such as code containers.

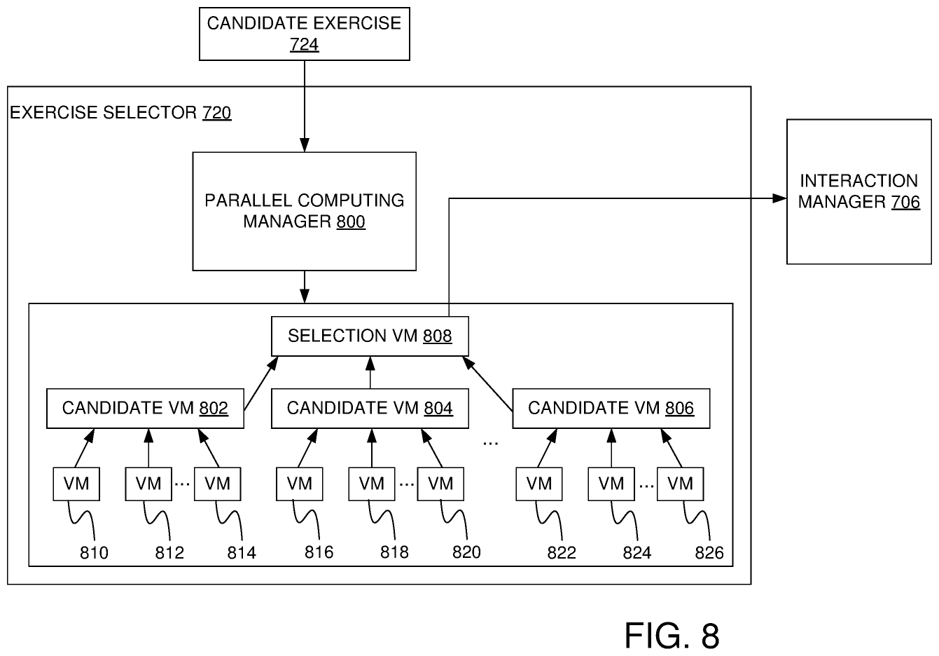

FIG. 8 provides an expanded block diagram of exercise selector 720 showing that a parallel computing manager 800 within exercise selector 720 starts candidate virtual machines, such as candidate virtual machines 802, 804 and 806, and a selection virtual machine 808 in step 606. Candidate virtual machines 802, 804 and 806 and selection virtual machine 808 are typically distributed across a server cluster. During operation, parallel computing manager 800 monitors the health of each server in the server cluster and should one of the servers fail, the candidate virtual machine on that server will be moved to a different server by parallel computing manager 800.

At step 608, in order to implement a multi-head system that attends to information from different representative spaces, parallel computing manager 800 starts multiple projection virtual machines for each of the candidate virtual machines. Each projection virtual machine, i, includes a respective self-attention layer that utilizes a query projection matrix Wᵢ^{Q} and a key projection matrix Wᵢ^{K} and includes a respective output layer that utilizes a value projection matrix Wᵢ^{V}, which are used in equations 7 and 9 above. Note that although three projection virtual machines are shown for each candidate virtual machine in FIG. 8, in other embodiments, more projection virtual machines are used.

For each candidate virtual machine, parallel computing manager 800 instructs the respective projection virtual machines that are started to provide their output to the candidate virtual machine they correspond to. Thus, parallel computing manager 800 instructs projection virtual machines 810, 812 and 814 to provide their output to candidate virtual machine 802, projection virtual machines 816, 818 and 820 to provide their output to candidate virtual machine 804, and projection virtual machines 822, 824 and 826 to provide their output to candidate virtual machine 806.

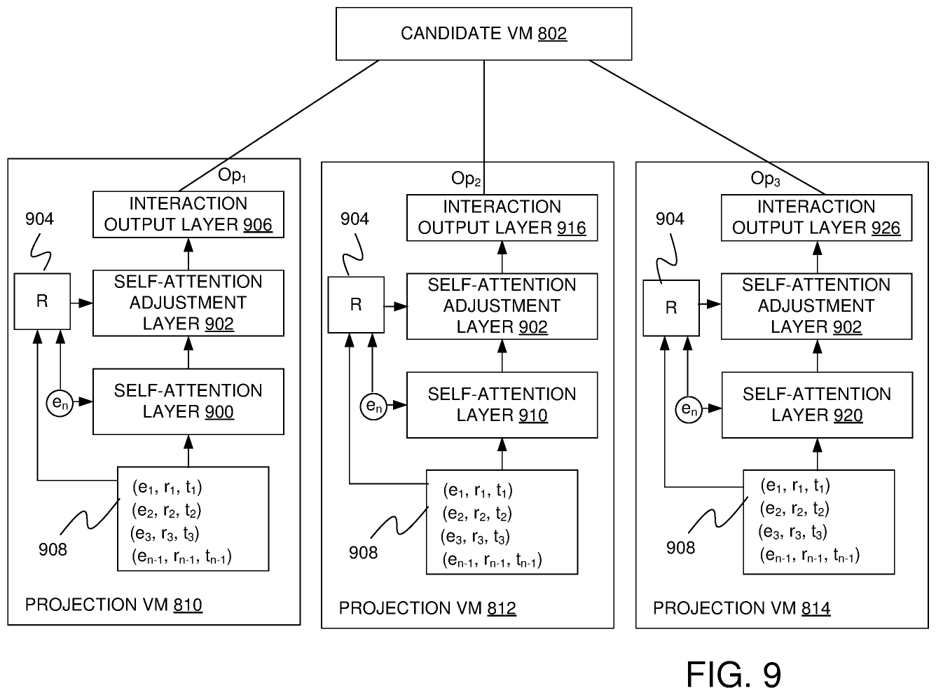

At step 610, each projection virtual machine generates a projection output in parallel with the other projection virtual machines. FIG. 9 provides an expanded block diagram of projection virtual machines 810, 812 and 814 connected to candidate virtual machine 802. As noted above, each projection virtual machine uses a different set of projection matrices Wᵢ^{Q}, Wᵢ^{K} and Wᵢ^{V}. As a result, each projection virtual machine 810, 812, and 814 has a respective self-attention layer 900, 910 and 920 that uses a respective Wᵢ^{Q} and Wᵢ^{K} and a respective output layer 906, 916, and 926 that uses a respective Wᵢ^{V}. Each projection virtual machine 810, 812, and 814 also includes a copy of a relation coefficient generator 904 and a self-attention adjustment layer 902, and a list 908 of the student's past interactions.

Respective self-attention layers 900, 910 and 920 each receive list 908 and use respective matrices Wᵢ^{Q} and Wᵢ^{K} to determine a self-attention weight, α, for each past interaction in list 908 relative to the candidate exercise associated with candidate virtual machine 802. In accordance with one embodiment, equation is used to determine the weights for each past interaction in list 908, with W^{Q} and W^{K} replaced by Wᵢ^{Q} and Wᵢ^{K} for the projection virtual machine. The operation of self-attention layers 900, 910 and 920 is shown by embedding layer 234, positional encoding 238 and scaled dot product 240 of FIG. 2.

In each projection virtual machine 810, 812 and 814, the self-attention weights from the respective self-attention layer 900, 910 and 920 are provided to a respective self-attention adjustment layer 902, which adjusts the self-attention weights based on relation coefficients produced by relation coefficient generator 904 for the candidate exercise of candidate virtual machine 802. In particular, a separate relation coefficient is provided for each past interaction in list 908. Each relation coefficient is calculated using equation 5 above and as discussed above represents the performance relationship between a past interaction and the candidate exercise of candidate virtual machine 802, the textual similarity between the past interaction and the candidate exercise, and a forget term based on the length of time between when the past interaction occurred and the current time (assumed to be the time at which the candidate exercise is performed). In accordance with one embodiment, an adjusted self-attention weight, β, is determined using equation 8 above for each self-attention weight α produced by self-attention layers 900, 910 and 920.

In each projection virtual machine, the respective adjusted self-attention weights, β, are provided to a respective output layer 906, 916, and 926 which uses the adjusted self-attention weights and a respective value matrix Wᵢ^{V} to generate a projection output for the projection matrices of the projection virtual machine. In accordance with one embodiment, each projection output is determined using equation 9 above using the respective value matrix Wᵢ^{V}. For example, output layer 906 of projection virtual machine 810 produces projection output Oₚ₁ for projection matrices W₁^{Q}, W₁^{K} and W₁^{V}; output layer 916 of projection virtual machine 812 produces projection output Oₚ₂ for projection matrices W₂^{Q}, W₂^{K} and W₂^{V}; and output layer 926 of projection virtual machine 814 produces projection output Oₚ₃ for projection matrices W₃^{Q}, W₃^{K} and W₃^{V}. As shown in FIG. 9, the projection outputs are each computed in parallel and are not dependent on the other projection outputs. This increases the speed of execution of the system and allows the computer system to find the projection outputs faster.

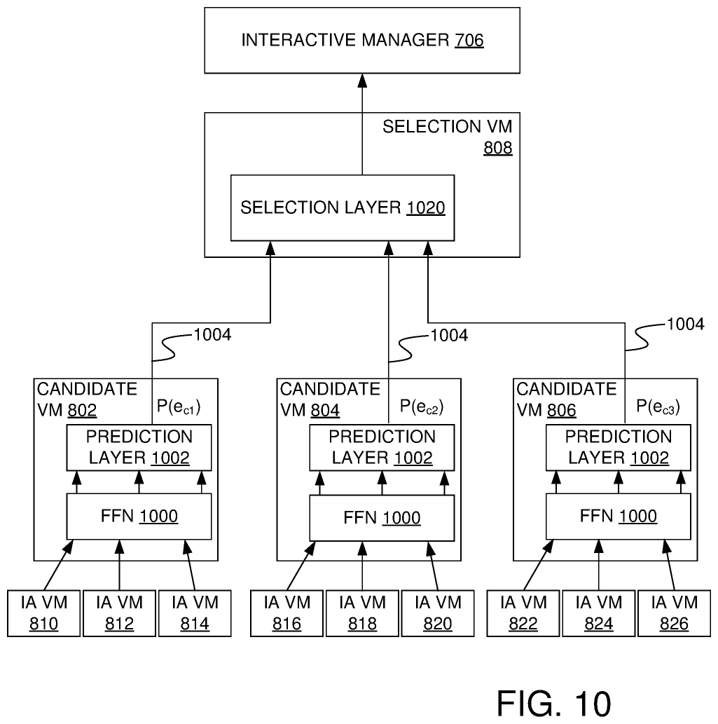

At step 612, each candidate virtual machine generates a probability for its respective candidate exercise such that the probabilities for each candidate exercise are determined in parallel. FIG. 10 provides an expanded block diagram of the candidate virtual machines. Each candidate virtual machine includes a feedforward layer 1000 that provides input to a prediction layer 1002 that generates the output for the candidate exercise as a probability 1004. Feedforward layer 1000 receives the projection outputs from the projection virtual machines and produces a representation for each past interaction with respect to the candidate exercise associated with the candidate virtual machine. Feedforward layer 1000 consists of two linear transformations with a ReLU nonlinear activation function between the linear transformations. The final output of FFN is F=ReLU(oW⁽¹⁾+b⁽¹⁾)W⁽²⁾+b⁽²⁾, where W⁽¹⁾∈ [symbol] ^{d×d}, W⁽²⁾∈ [symbol] ^{d×d} are weight matrices and b⁽¹⁾∈Rd and b⁽²⁾∈R^{d×d} are the bias vectors and o is matrix of projection outputs.

Prediction layer 1002 uses the representations produced by feedforward layer 1000 to determine a probability for the candidate exercise. In particular, prediction layer 1002 uses a fully connected network with Sigmoid activation to predict the performance of the student.

p=σ(FW+b), (10)

where p is a scalar and represents the probability of student providing correct response to exercise eₙ, and σ(z)=1/(1+e^{-z}).

Since candidate virtual machines 802, 804 and 806 each operate in parallel, the probability for each candidate exercise is determined in parallel resulting in faster and scalable operation of the probability prediction layer. In particular, the system runs at the same speed regardless of how many candidate exercises are available for the student. This greatly improves the computing system and its ability to quickly identify a best candidate exercise for a student.

At step 614, a selection layer 1020 in selection virtual machine 808 receives each of the probabilities for each candidate exercise and selects one of the candidate exercises based on those probabilities. The selected candidate exercise is provided by selection layer 1020 to interactive manager 706, which then returns the selected exercise to the student at step 616 through user interface 702 so that the student may perform the exercise. Interaction manager 706 tracks the student's performance including the correctness of the response provided by the student and the time at which the student completed the exercise. Interaction manager 706 stores the selected exercise, the correctness of the student's response and the time at which the student completed the exercise in interaction database 710. As a result, the selected exercise will be used in determining which exercise to provide to the user when the method of FIG. 6 is next performed.

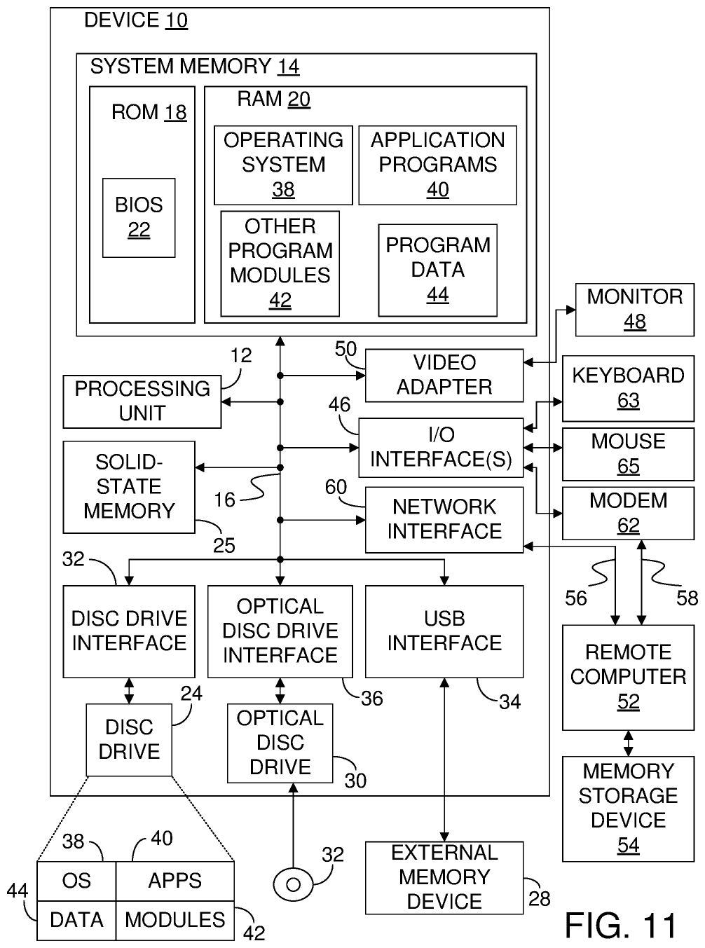

FIG. 11 provides an example of a computing device 10 that can be used to implement one or more of the servers discussed above. Computing device 10 includes a processing unit 12, a system memory 14 and a system bus 16 that couples the system memory 14 to the processing unit 12. System memory 14 includes read only memory (ROM) 18 and random-access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Computing device 10 further includes an optional hard disc drive 24, an optional external memory device 28, and an optional optical disc drive 30. External memory device 28 can include an external disc drive or solid-state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of the applications discussed above. Program data 44 may include any data used by the systems and methods discussed above.

Processing unit 12, also referred to as a processor, executes programs in system memory 14 and solid-state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 11. The network connections depicted in FIG. 10 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 11 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A method comprising:
conserving processor resources by reducing a number of exercises presented to a student through steps comprising:
applying a set of exercises performed by the student and the student's performance on those exercises to a neural network;
applying a respective time period for each exercise in the set of exercises to the neural network wherein each time period represents an amount of time since the student performed the exercise associated with the time period;
for a candidate next exercise, obtaining from the neural network a likelihood of the student successfully performing the candidate next exercise; and
using the likelihood to select an exercise to present to the student next.

2. The method of claim 1 wherein applying the set of exercises performed by the student and the student's performance on those exercises to a neural network comprises applying the set of exercises performed by the student and the student's performance on those exercises to a neural network having self-attention such that the neural network generates an attention weight for each exercise performed by the student.

3. The method of claim 2 wherein applying a time period to the neural network comprises using the respective time period to alter the attention weight for the exercise associated with the time period to form an altered attention weight for the exercise associated with the time period.

4. The method of claim 1 further comprising applying a relation value for each exercise in the set of exercises to the neural network, the relation value for an exercise in the set of exercises representing a relation between the exercise in the set of exercises and the candidate next exercise.

5. The method of claim 4 wherein the relation value for an exercise in the set of exercises represents a degree of semantic similarity between the exercise in the set of exercises and the candidate next exercise.

6. The method of claim 4 wherein the relation value for an exercise in the set of exercises represents a degree to which ability to perform the exercise in the set of exercises predicts the ability to perform the candidate next exercise.

7. The method of claim 5 wherein the relation value for an exercise in the set of exercises further represents a degree to which ability to perform the exercise in the set of exercises predicts the ability to perform the candidate next exercise.

8. The method of claim 1 further comprising reducing the time required to select an exercise to present to the student next by executing a separate neural network for each candidate next exercise of a plurality of candidate next exercises so as to obtain a likelihood of the student successfully performing each candidate next exercise in parallel.

9. A system comprising:
a plurality of neural networks operating in parallel, each neural network in the plurality providing a likelihood of a student successfully performing a respective candidate next exercise of a plurality of candidate next exercises, each neural network comprising:
a first network layer receiving a plurality of input values and outputting a plurality of output values; and
a second network layer receiving the plurality of output values provided by the first network layer and using the plurality of output values to generate a likelihood of a the student successfully performing the respective candidate next exercise associated with the neural network; and
a selection layer that receives the likelihoods produced by the plurality of neural networks and that selects one of the plurality of candidate next exercises as a next exercise the student should perform based on the likelihoods produced by the plurality of neural networks.

10. The system of claim 9 wherein the plurality of input values provided to the first network layer are generated in parallel by a plurality of neural networks operating in parallel.

11. The system of claim 10 wherein the plurality of neural networks operating in parallel to produce the input values to the first network layer each comprise:
a self-attention layer generating self-attention weights for each past exercise performed by the student;
a self-attention weight adjustment layer that applies a respective self-attention weight adjustment to each self-attention weight to produce a plurality of adjusted self-attention weights, each self-attention weight adjustment being based on:
a relation between the exercise performed by the student that is associated with the self-attention weight and a candidate next exercise; and
a time since the exercise performed by the student that is associated with the self-attention weight was performed by the student; and
an output layer that generates an input value for the first network layer based on the plurality of adjusted self-attention weights.

12. The system of claim 11 wherein the relation comprises a semantic similarity between the exercise performed by the student and the candidate next exercise.

13. The system of claim 10 wherein the semantic similarity is determined from an embedding of the exercise performed by the student and an embedding of the candidate next exercise and wherein the self-attention weight layer utilizes the embedding of the exercise performed by the student.

14. The system of claim 11 wherein the relation comprises a value representing a degree to which an ability to perform the past exercise performed by the student predicts the ability to perform the candidate next exercise.

15. The system of claim 12 wherein the relation further comprises a value representing a degree to which an ability to perform the past exercise performed by the student predicts the ability to perform the candidate next exercise.

16. A method comprising:
conserving processor resources by reducing a number of exercises presented to a student through steps comprising:
applying a set of exercises performed by the student and the student's performance on those exercises to a neural network;
applying a relation value for each exercise in the set of exercises to the neural network, the relation value for an exercise in the set of exercises representing a relation between the exercise in the set of exercises and a candidate next exercise;
for the candidate next exercise, obtaining from the neural network a likelihood of the student successfully performing the candidate next exercise; and
using the likelihood to select an exercise to present to the student.

17. The method of claim 16 wherein applying the set of exercises performed by the student and the student's performance on those exercises to a neural network comprises applying the set of exercises performed by the student and the student's performance on those exercises to a neural network having self-attention such that the neural network generates an attention weight for each exercise performed by the student.

18. The method of claim 17 further comprising applying a respective time period for each exercise in the set of exercises to the neural network wherein each time period represents an amount of time since the student performed the exercise associated with the time period.

19. The method of claim 18 wherein applying a respective time period to the neural network comprises using the respective time period to alter the attention weight for the exercise associated with the time period to form an altered attention weight for the exercise associated with the time period.

20. The method of claim 16 wherein the relation value for an exercise in the set of exercises represents a degree to which ability to perform the exercise in the set of exercises predicts the ability to perform the candidate next exercise.
